(19) United States
(12) Patent Application Publication
(10) Pub. No.: US 2015/0029370 A1
(43) Pub. Date: Jan. 29, 2015

(54) SOLID-STATE IMAGING DEVICE

(71) Applicant: Kabushiki Kaisha Toshiba, Minato-ku (JP)

(72) Inventors: Takahiko MIHARA, Yokohama-shi (JP); Yukiyasu Tatsuzawa, Yokohama-shi (JP)

(73) Assignee: Kabushiki Kaisha Toshiba, Minato-ku (JP)

(21) Appl. No.: 14/187,464

(22) Filed: Feb. 24, 2014

(30) Foreign Application Priority Data
Jul. 26, 2013 (JP) 2013-155437

(51) Int. Cl. H04N 5/335; H04N 5/235

(52) U.S. Cl. CPC H04N 5/335; H04N 5/2353
USPC 348/302

(57) ABSTRACT

According to one embodiment, in a pixel array section, pixels that accumulate photoelectrically-converted charges are arranged in a matrix shape. An exposure-period control section controls an exposure period of the pixels for each of fields and controls readout timing such that interlace readout is performed from the pixel array section. A charge-discharging control section performs discharge control for charges accumulated in the pixels in a non-exposure period of the pixels.

### CROSS-REFERENCE TO RELATED APPLICATIONS

This application is based upon and claims the benefit of priority from Japanese Patent Application No. 2013-155437, filed on Jul. 26, 2013; the entire contents of which are incorporated herein by reference.

### FIELD

Embodiments described herein relate generally to solid-state imaging device.

### BACKGROUND

To expand a dynamic range while maintaining the sensitivity during low illuminance, some solid-state imaging device sets, in interlace readout, exposure times separately for odd number fields and even number fields and combines the odd number fields and the even number fields to obtain one image.

### BRIEF DESCRIPTION OF THE DRAWINGS

FIG. 1 is a block diagram of the schematic configuration of a solid-state imaging device according to a first embodiment;

FIG. 2 is a circuit diagram of a configuration example of a pixel of the solid-state imaging device shown in FIG. 1;

FIG. 3A is a timing chart of voltage waveforms of sections of the pixel shown in FIG. 2 in an odd number field exposure period;

FIG. 3B is a timing chart of voltage waveforms of the sections of the pixel shown in FIG. 2 in an even number field exposure period;

FIG. 4A is a timing chart of reset timings and readout timings for odd number fields and even number fields under a first condition in each of lines;

FIG. 4B is a timing chart of a PD charge amount in the odd number field exposure period;

FIG. 4C is a timing chart of a PD charge amount in the even number field exposure period;

FIG. 5 is a timing chart of reset timings and readout timings for the odd number fields and the even number fields under a second condition in each of lines;

FIG. 6 is a timing chart of reset timings and readout timings for the odd number fields and the even number fields under a third condition in each of the lines;

FIG. 7 is a timing chart of reset timings and readout timings for the odd number fields and the even number fields under a fourth condition in each of the lines;

FIG. 8 is a flowchart for explaining pre-reset operations under the first to fourth conditions shown in FIGS. 4A to 7;

FIG. 9 is a block diagram of the schematic configuration of an image processing apparatus that combines signals read out in the odd number field exposure period and the even number field exposure period; and

FIG. 10 is a block diagram of the schematic configuration of a digital camera applied with a solid-state imaging device according to a second embodiment.

### DETAILED DESCRIPTION

In general, according to one embodiment, a solid-state imaging device includes a pixel array section, an exposure-period control section, and a charge-discharging control section. In the pixel array section, pixels that accumulate photoelectrically-converted charges are arranged in a matrix shape. The exposure-period control section controls an exposure period of the pixels for each of fields and controls readout timing such that interlace readout is performed from the pixel array section. The charge-discharging control section performs discharge control for charges accumulated in the pixels in a non-exposure period of the pixels.

Exemplary embodiments of a solid-state imaging device according to an embodiment will be explained below in detail with reference to the accompanying drawings. The present invention is not limited to the following embodiments.

### First Embodiment

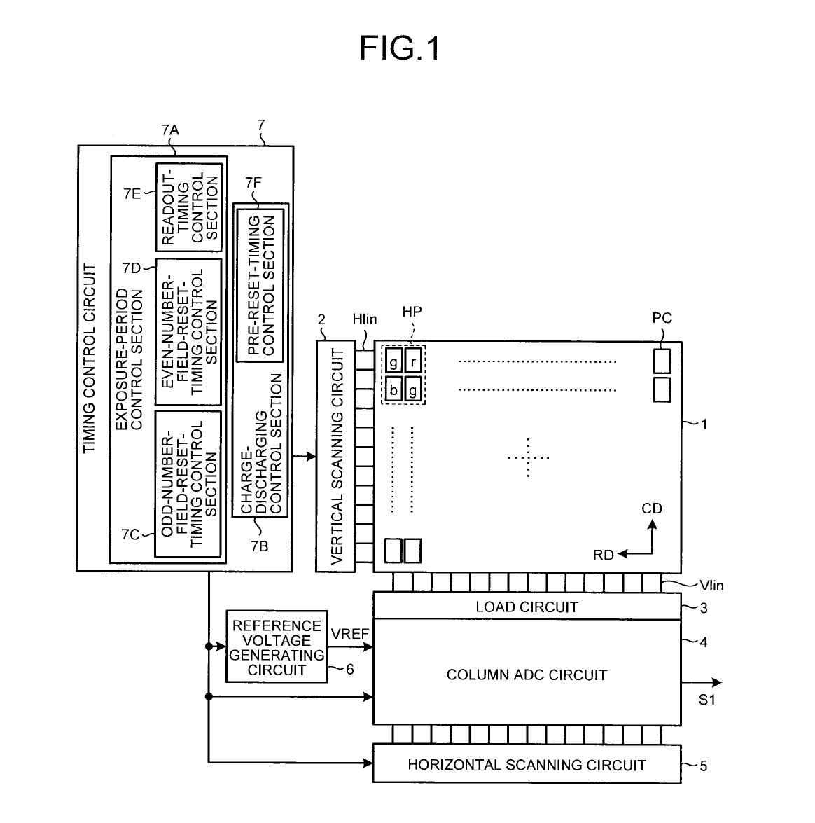

FIG. 1 is a block diagram of the schematic configuration of a solid-state imaging device according to a first embodiment.

In FIG. 1, a pixel array section 1 is provided in the solid-state imaging device. In the pixel array section 1, pixels PC that accumulate photoelectrically-converted charges are arranged in a matrix shape in a row direction RD and a column direction CD. In the pixel array section 1, horizontal control lines Hlin for performing readout control for the pixels PC are provided in the row direction RD and vertical signal lines Vlin for transmitting signals read out from the pixels PC are provided in the column direction CD.

In the solid-state imaging device, a vertical scanning circuit 2, a load circuit 3, a column ADC circuit 4, a horizontal scanning circuit 5, a reference voltage generating circuit 6, and a timing control circuit 7 are provided. The vertical scanning circuit 2 scans readout target pixels PC in the vertical direction. The load circuit 3 performs a source follower operation between the load circuit 3 and the pixels PC to thereby read out signals from the pixels PC to the vertical signal lines Vlin for each of columns. The column ADC circuit 4 detects signal components of the pixels PC in a CDS for each of the columns. The horizontal scanning circuit 5 scans readout target pixels PC in the horizontal direction. The reference voltage generating circuit 6 outputs a reference voltage VREF to the column ADC circuit 4. The timing control circuit 7 controls timings for readout and accumulation of the pixels PC. As the reference voltage VREF, a ramp wave can be used.

In the pixel array section 1, to colorize a picked-up image, a Bayer array HP including four pixels PC as one set can be formed. In the Bayer array HP, two pixels for green g are arranged in one diagonal direction and one pixel for red r and one pixel for blue b are arranged in the other diagonal direction.

In the timing control circuit 7, an exposure-period control section 7A and a charge-discharging control section 7B are provided. In the exposure-period control section 7A, an odd-number-field-reset-timing control section 7C, an even-number-field-reset-timing control section 7D, and a readout-timing control section 7E are provided. In the charge-discharging control section 7B, a pre-reset-timing control section 7F is provided. The exposure-period control section 7A controls an exposure period of the pixels PC for each of fields and controls readout timing such that interlace readout is performed from the pixel array section 1. The charge-discharging control section 7B performs discharge control for charges accumulated in the pixels PC in a non-exposure period of the pixels PC. The readout-timing control section 7E controls readout timing for charges accumulated in the pixels PC such that interlace readout is performed from the pixel array section 1. The odd-number-field-reset-timing control section 7C controls reset timing for charges accumulated in the pixels PC in odd number fields. The even-number-field-reset-timing control section 7D controls reset timing for charges accumulated in the pixels PC in even number fields. In an odd number field or even number field non-exposure period, the pre-reset-timing control section 7F controls reset timing for charges accumulated in the pixels PC in the odd number fields or the even number fields. The odd number fields and the even number fields can be alternately set on the pixel array section 1. For example, in the Bayer array HP, the odd number fields can be set in a 4n+1th (n is an integer equal to or larger than 0) row and a 4n+2th row of the pixel array section 1 and the even number fields can be set in a 4n+3th row and a 4n+4th row of the pixel array section 1.

The vertical scanning circuit 2 scans the pixels PC in the vertical direction, whereby the pixels PC are selected in the row direction RD. The load circuit 3 performs the source follower operation between the load circuit 3 and the pixels PC, whereby signals read out from the pixels PC are sent to the column ADC circuit 4 via the vertical signal lines Vlin. The reference-voltage generating circuit 6 sets a ramp wave as the reference voltage VREF and sends the ramp wave to the column ADC circuit 4. The column ADC circuit 4 performs a clock count operation until a signal level read out from the pixels PC and a reset level coincide with a level of the ramp wave and calculates a difference between the signal level and the reset level at that point. Consequently, signal components of the pixels PC are detected by the CDS and output as an output signal S1.

It is possible to vary the sensitivity of the pixels PC in the odd number fields and the even number fields by controlling reset timing for charges accumulated in the pixels PC to vary exposure times in the odd number fields and the even number fields. Therefore, it is possible to improve a dynamic range by combining the output signal S1 generated from the pixels PC in the odd number fields and the output signal S1 generated from the pixels PC in the even number fields.

In the odd number field or even number field non-exposure period, it is possible to reduce charges accumulated in the pixels PC in the odd number fields or the even number fields in the non-exposure period. Therefore, it is possible to suppress charges accumulated in the pixels PC in the odd number fields or the even number fields in the non-exposure period from overflowing to adjacent pixels and it is possible to reduce blooming.

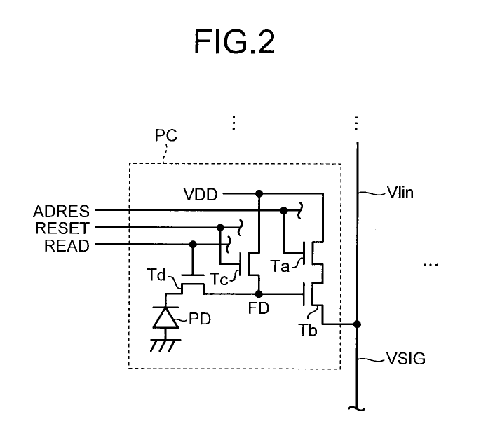

FIG. 2 is a circuit diagram of a configuration example of the pixel of the solid-state imaging device shown in FIG. 1.

In FIG. 2, in the pixel PC, a photodiode PD, a row selection transistor Ta, an amplifier transistor Tb, a reset transistor Tc, and a readout transistor Td are provided. A floating diffusion FD is formed as a detection node at a connection point of the amplifier transistor Tb, the reset transistor Tc, and the readout transistor Td.

A source of the readout transistor Td is connected to the photodiode PD. A readout signal READ is input to a gate of the readout transistor Td. A source of the reset transistor Tc is connected to a drain of the readout transistor Td. A reset signal RESET is input to a gate of the reset transistor Tc. A drain of the reset transistor Tc is connected to power supply potential VDD. A row selection signal ADRES is input to a gate of the row selection transistor Ta. A drain of the row selection transistor Ta is connected to the power supply potential VDD. A source of the amplifier transistor Tb is connected to the vertical signal line Vlin. A gate of the amplifier transistor Tb is connected to the drain of the readout transistor Td. A drain of the amplifier transistor Tb is connected to a source of the row selection transistor Ta.

The horizontal control line Hlin can transmit the readout signal READ, the reset signal RESET, and the row selection signal ADRES to the pixel P for each of rows.

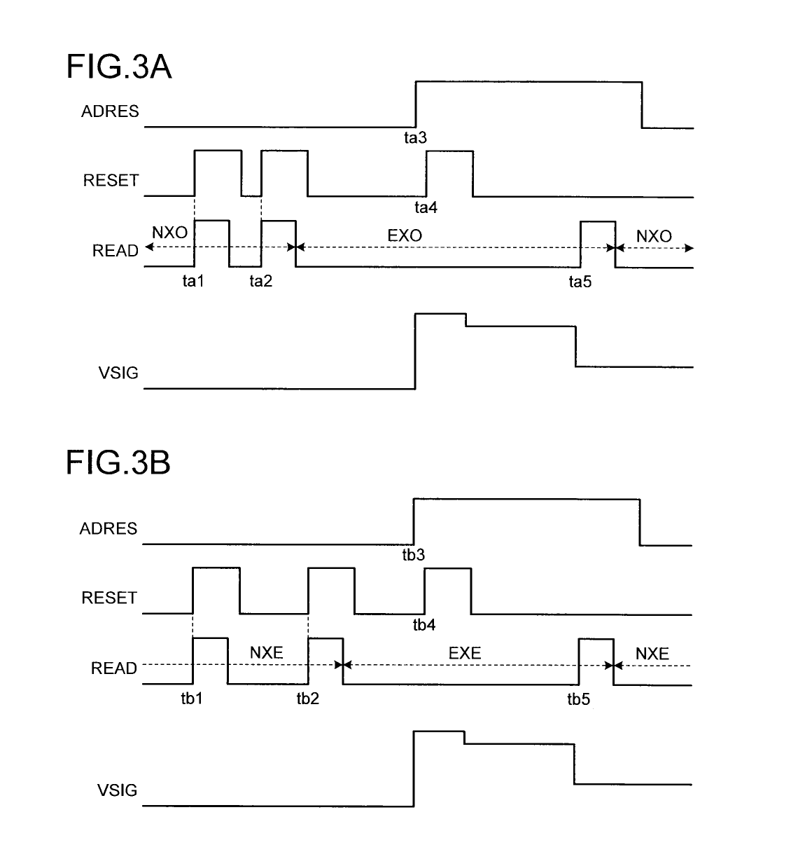

FIG. 3A is a timing chart of voltage waveforms of the sections of the pixel shown in FIG. 2 in an odd number field exposure period. FIG. 3B is a timing chart of voltage waveforms of the sections of the pixel shown in FIG. 2 in an even number field exposure period.

In FIG. 3A, an odd number field exposure period EXO is set to the pixel PC in the odd number field of the pixel array section 1 shown in FIG. 1. In FIG. 3B, an even number field exposure period EXE is set to the pixel PC in the even number field of the pixel array section 1 shown in FIG. 1. At this point, the odd number field exposure period EXO can be set longer than the even number field exposure period EXE. The even number field exposure period EXE can be set longer than the odd number field exposure period EXO.

As shown in FIG. 3A, in the pixel PC in the odd number field, when the row selection signal ADRES is at a low level, the row selection transistor Ta changes to an OFF state. A pixel signal VSIG is not output to the vertical signal line Vlin. At this point, when the readout signal READ and the reset signal RESET change to a high level (ta1), the readout transistor Td is turned on. Charges accumulated in the photodiode PD in an odd number field non-exposure period NXO are discharged to the floating diffusion FD. The charges are discharged to the power supply potential VDD via the reset transistor Tc.

After the charges accumulated in the photodiode PD in the odd number field non-exposure period NXO are discharged to the power supply voltage VDD, when the readout signal READ changes to the low level, in the photodiode PD, accumulation of charges in the odd number field non-exposure period is started.

Thereafter, when the readout signal READ and the reset signal RESET change to the high level again (ta2), the readout transistor Td is turned on. The charges accumulated in the photodiode PD in the odd number non-exposure period NXO are discharged to the floating diffusion FD again. The charges are discharged to the power supply potential VDD via the reset transistor Tc.

After the charges accumulated in the photodiode PD in the odd number field non-exposure period NXO are discharged to the power supply voltage VDD again, when the readout signal READ changes to the low level, in the photodiode PD, accumulation of effective signal charges is started. The odd number field non-exposure period NXO shifts to the odd number field exposure period EXO.

Subsequently, when the row selection signal ADRES changes to the high level (ta3), the row selection transistor Ta of the pixel PC is turned on. The power supply potential VDD is applied to the drain of the amplifier transistor Tb.

When the reset signal RESET changes to the high level in the ON state of the row selection transistor Ta (ta4), the reset transistor Tc is turned on. Excess charges generated by a leak current or the like in the floating diffusion FD are reset. A voltage corresponding to a reset level of the floating diffusion FD is applied to the gate of the amplifier transistor Tb. The voltage of the vertical signal line Vlin follows the voltage applied to the gate of the amplifier transistor Tb, whereby the pixel signal VSIG at the reset level is output to the vertical signal line Vlin.

The pixel signal VSIG at the reset level is input to the column ADC circuit 4 and compared with the reference voltage VREF. The pixel signal VSIG at the reset level is converted into a digital value based on a result of the comparison and retained.

Subsequently, when the readout signal READ changes to the high level in the ON state of the row selection transistor Ta of the pixel PC (ta5), the readout transistor Td is turned on. The charges accumulated in the photodiode PD in the odd number field exposure period EXO are transferred to the floating diffusion FD. A voltage corresponding to a signal readout level of the floating diffusion FD is applied to the gate of the amplifier transistor Tb. The voltage of the vertical signal line Vlin follows the voltage applied to the gate of the amplifier transistor Tb, whereby the pixel signal VSIG at the signal readout level is output to the vertical signal line Vlin.

The pixel signal VSIG at the signal readout level is input to the column ADC circuit 4 and compared with the reference voltage VREF. A difference between the pixel signal VSIG at the reset level and the pixel signal VSIG at the signal readout level is converted into a digital value based on a result of the comparison and output as the output signal S1 corresponding to the odd number field exposure period EXO.

On the other hand, as shown in FIG. 3B, in the pixel PC in the even number field, when the row selection signal ADRES is at the low level, the row selection transistor Ta changes to an OFF state. The pixel signal VSIG is not output to the vertical signal line Vlin. At this point, when the readout signal READ and the reset signal RESET change to the high level (tb1), the readout transistor Td is turned on. Charges accumulated in the photodiode PD in an even number field non-exposure period NXE are discharged to the floating diffusion FD. The charges are discharged to the power supply potential VDD via the reset transistor Tc.

After the charges accumulated in the photodiode PD in the even number field non-exposure period NXE are discharged to the power supply potential VDD, when the readout signal READ changes to the low level, in the photodiode PD, accumulation of charges in the even number field non-exposure period NXE is started.

Thereafter, when the readout signal READ and the reset signal RESET change to the high level again (tb2), the readout transistor Td is turned on. The charges accumulated in the photodiode PD during the even number field non-exposure period NXE are discharged to the floating diffusion FD again. The charges are discharged to the power supply potential VDD via the reset transistor Tc.

After the charges accumulated in the photodiode PD in the even number field non-exposure period NXE are discharged to the power supply potential VDD again, when the readout signal READ changes to the low level, in the photodiode PD, accumulation of effective signal charges is started. The even number field non-exposure period NXE shifts to the even number field exposure period EXE.

When the row selection signal ADRES changes to the high level (tb3), the row selection transistor Ta of the pixel PC is turned on. The power supply potential VDD is applied to the drain of the amplifier transistor Tb.

When the reset signal RESET changes to the high level in the ON state of the row selection transistor Ta (tb4), the reset transistor Tc is turned on. Excess charges generated by a leak current or the like in the floating diffusion FD are reset. A voltage corresponding to the reset level of the floating diffusion FD is applied to the gate of the amplifier transistor Tb. The voltage of the vertical signal line Vlin follows the voltage applied to the gate of the amplifier transistor Tb, whereby the pixel signal VSIG at the reset level is output to the vertical signal line Vlin.

The pixel signal VSIG at the reset level is input to the column ADC circuit 4 and compared with the reference voltage VREF. The pixel signal VSIG at the reset level is converted into a digital value based on a result of the comparison and retained.

Subsequently, when the readout signal READ changes to the high level in the ON state of the row selection transistor Ta of the pixel PC (tb5), the readout transistor Td is turned on. Charges accumulated in the photodiode PD in the even number field exposure period EXE are transferred to the floating diffusion FD. A voltage corresponding to the signal readout level of the floating diffusion FD is applied to the gate of the amplifier transistor Tb. The voltage of the vertical signal line Vlin follows the voltage applied to the gate of the amplifier transistor Tb, whereby the pixel signal VSIG at the signal readout level is output to the vertical signal line Vlin.

The pixel signal VSIG at the signal readout level is input to the column ADC circuit 4 and compared with the reference voltage VREF. A difference between the pixel signal VSIG at the reset level and the pixel signal VSIG at the signal readout level is converted into a digital value based on a result of the comparison and output as the output signal S1 corresponding to the even number field exposure period EXE.

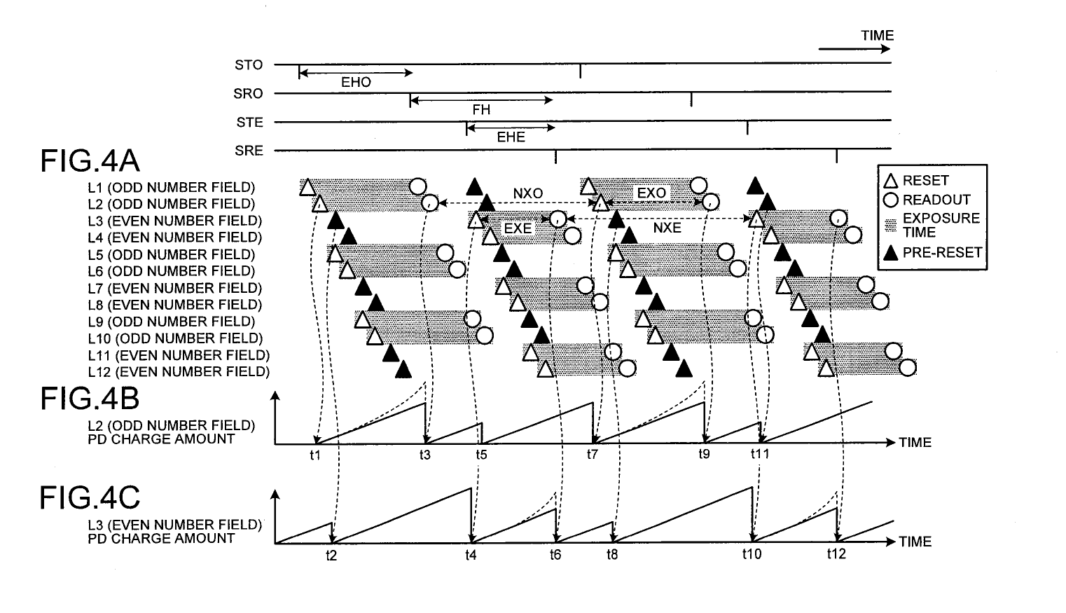

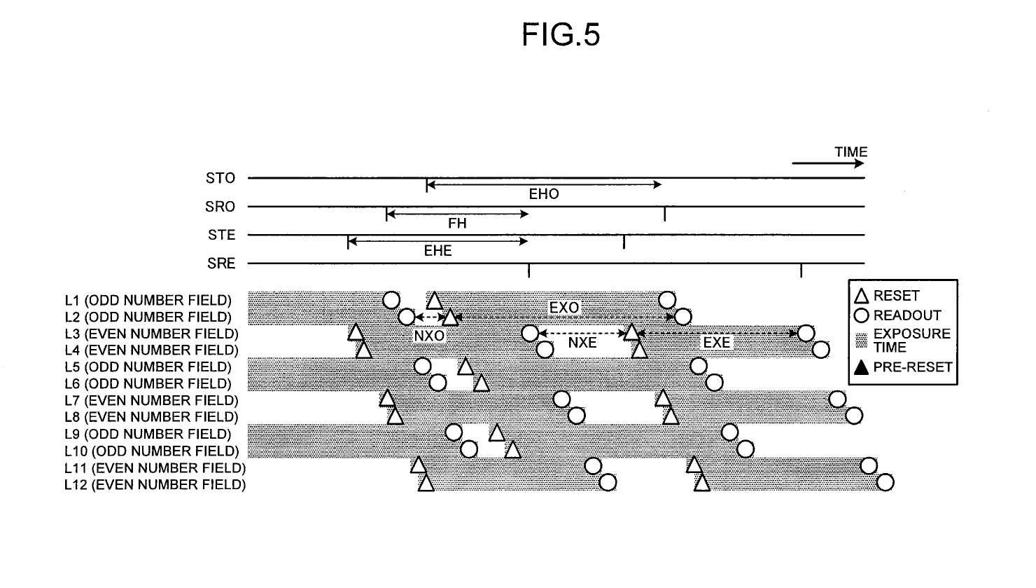

FIG. 4A is a timing chart of reset timings and readout timings for odd number fields and even number fields under a first condition in each of lines. FIG. 4B is a timing chart of a PD charge amount in the odd number field exposure period. FIG. 4C is a timing chart of a PD charge amount in the even number field exposure period. In examples shown in FIGS. 4A to 4C, the pixels PC form the Bayer array HP. Odd number fields (lines L1, L2, L5, L6, L9, and L10) and even number fields (lines L3, L4, L7, L8, L11, and L12) are alternately set for every two lines. The first condition is that an odd number field exposure time EHO and an even number field exposure time EHE are shorter than one frame time FH. Under the first condition, pre-reset is performed in the odd number field non-exposure period NXO and the even number field non-exposure period NXE.

In FIGS. 4A to 4C, in the lines L1, L2, L5, L6, L9, and L10, the odd number field exposure period EXO and the odd number field non-exposure period NXO are set. In the lines L3, L4, L7, L8, L11, and L12, the even number field exposure period EXE and the even number field non-exposure period NXE are set.

For example, in the pixels PC on the line L2, charges accumulated in the photodiode PD in the odd number field non-exposure period NXO are discharged (t1 and t7), whereby the odd number field non-exposure period NXO shifts to the odd number field exposure period EXO. Subsequently, charges accumulated in the photodiode PD in the odd number field exposure period EXO are read out (t3 and t9), whereby the odd number field exposure period EXO shifts to the odd number field non-exposure period NXO. The charges accumulated in the photodiode PD in the odd number field non-exposure period NXO are discharged (t5 and t11). The odd number field non-exposure period NXO is maintained.

On the other hand, for example, in the pixels PC on the line L3, charges accumulated in the photodiode PD in the even number field non-exposure period NXE are discharged (t4 and t10), whereby the even number field non-exposure period NXE shifts to the even number field exposure period EXE. Subsequently, charges accumulated in the photodiode PD in the even number field exposure period EXE are read out (t6 and t12), whereby the even number field exposure period EXE shifts to the even number field non-exposure period NXE. The charges accumulated in the photodiode PD in the even number field non-exposure period NXE are discharged (t2 and t8). The even number field non-exposure period NXE is maintained.

Reset of the odd number fields is performed according to an odd number field reset synchronization signal STO. Readout of the odd number fields is performed according to an odd number field readout synchronization signal SRO. Reset of the even number fields is performed according to an even number field reset synchronization signal STE. Readout of the even number fields is performed according to an even number field readout synchronization signal SRE. In FIG. 4A, the odd number field reset synchronization signal STO and the odd number field readout synchronization signal SRO are shown with respect to the line L1. The even number field reset synchronization signal STE and the even number field readout synchronization signal SRE are shown with respect to the line L3.

When the odd number field exposure time EHO and the even number field exposure time EHE are shorter than the one frame time FH, the even number field non-exposure period NXE and the odd number field non-exposure period NXO are longer than the one frame time FH. As a result, when an incident light amount of the photodiode PD is large, charges accumulated in the photodiode PD in the even number field non-exposure period NXE and the odd number field non-exposure period NXO overflow. The charges flow into the pixels PC on the line L2 from the pixels PC on the line L3 or the charges flow into the pixels PC on the line L3 from the pixels PC on the line L2. When the charges flow into the pixels PC on the line L2 from the pixels PC on the line L3, a charge amount of the pixels PC on the line L2 increases as indicated by a dotted line and blooming occurs. When the charges flow into the pixels PC on the line L3 from the pixels PC on the line L2, a charge amount of the pixels PC on the line L3 increases as indicated by a dotted line and blooming occurs. Therefore, the charges accumulated in the photodiode PD in the even number field non-exposure period NXE and the odd number field non-exposure period NXO are repeatedly discharged from the photodiode PD a plurality of times in the even number field non-exposure period NXE and the odd number field non-exposure period NXO. Consequently, it is possible to reduce a charge amount accumulated in the photodiode PD in the even number field non-exposure period NXE and the odd number field non-exposure period NXO. It is possible to suppress the charges accumulated in the photodiode PD in the even number field non-exposure period NXE and the odd number field non-exposure period NXO from overflowing.

A time interval between lines of pre-reset timings in the even number field non-exposure period NXE and the odd number field non-exposure period NXO can be set equal to a time interval between lines of reset timings for starting the odd number field exposure period EXO and the even number field exposure period EXE. At this point, for example, pre-reset timing for the line L2 can be set equal to reset timing for the line L4. Pre-reset timing for the line L3 can be set equal to reset timing for the line L5. Consequently, pre-reset timings for the odd number fields and the even number fields can be matched with reset timings for the odd number fields and the even number fields. Because it is possible to simplify control of the timings, it is possible to prevent complication of a circuit configuration.

FIG. 5 is a timing chart of reset timings and readout timings for the odd number fields and the even number fields under a second condition in each of lines. The second condition is that the odd number field exposure time EHO and the even number field exposure time EHE are equal to or longer than the one frame time FH. Under the second condition, pre-reset is not performed in the odd number field non-exposure period NXO and the even number field non-exposure period NXE.

In FIG. 5, when the odd number field exposure time EHO and the even number field exposure time EHE are equal to or longer than the one frame time FH, the even number field non-exposure period NXE and the odd number field non-exposure period NXO are shorter than the one frame time FH. An incident light amount of the photodiode PD is small when an exposure time is set long. Therefore, charges accumulated in a non-exposure period are also small. As a result, it is possible to suppress occurrence of blooming even if pre-reset is not performed.

When pre-reset is not performed in the odd number field non-exposure period NXO and the even number field non-exposure period NXE, it is possible to prevent pre-reset from being inserted into a position where the pre-reset cannot be matched with reset timings for the odd number fields and the even number fields. Therefore, it is possible to prevent complication of a circuit configuration.

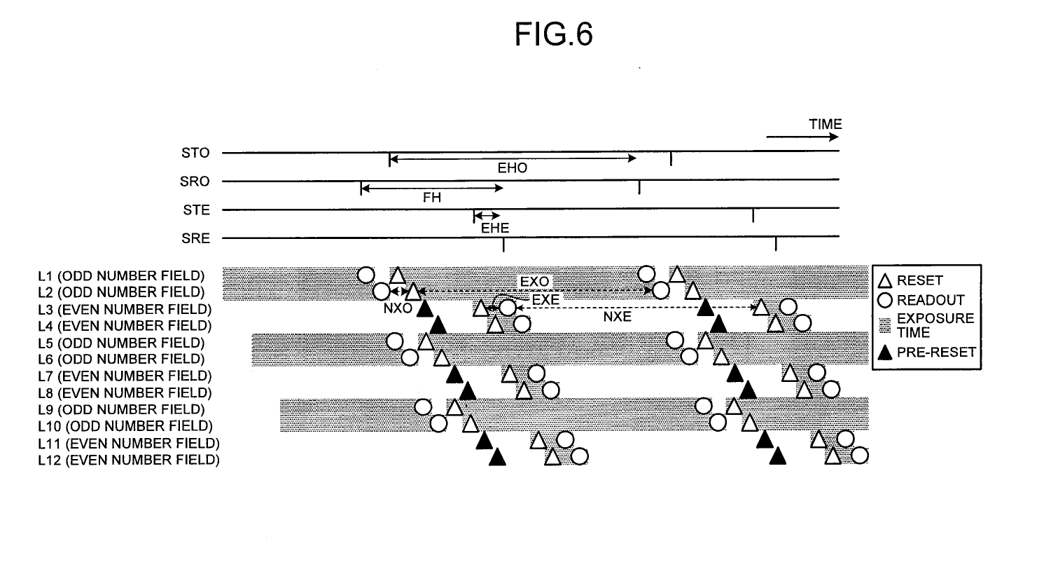

FIG. 6 is a timing hart of reset timings and readout timings for the odd number fields and the even number fields under a third condition in each of the lines. The third condition is that one of the odd number field exposure time EHO and the even number field exposure time EHE is equal to or longer than the one frame time FH, the other is shorter than the one frame time FH, and a sum of the shorter exposure time and the one frame time FH is equal to or shorter than the longer exposure time. Under the third condition, pre-reset of a non-exposure period in only a field in which the non-exposure time is longer is performed. In an example shown in FIG. 6, the odd number field exposure time EHO is longer than the even number field exposure time EHE.

In FIG. 6, when the odd number field exposure time EHO is equal to or longer than the one frame time FH, the even number field exposure time EHE is shorter than the one frame time FH, and a sum of the even number field exposure time EHE and the one frame time FH is equal to or shorter than the odd number field exposure time EHO, the odd number field non-exposure period NXO is shorter than the one frame time FH and the even number field non-exposure period NXE is longer than the one frame time FH. In this case, because the odd number field non-exposure period NXO is short, a charge amount accumulated in the photodiode PD is small. When pre-reset is performed during the even number field non-exposure period NXE, it is possible to discharge charges accumulated in the photodiode PD in the even number field non-exposure period NXE and it is possible to suppress occurrence of blooming.

When pre-reset is not performed in the odd number field non-exposure period NXO, it is possible to prevent pre-reset from being inserted in a position where the pre-reset cannot be matched with reset timings for the odd number fields and the even number fields. Therefore, it is possible to prevent complication of a circuit configuration.

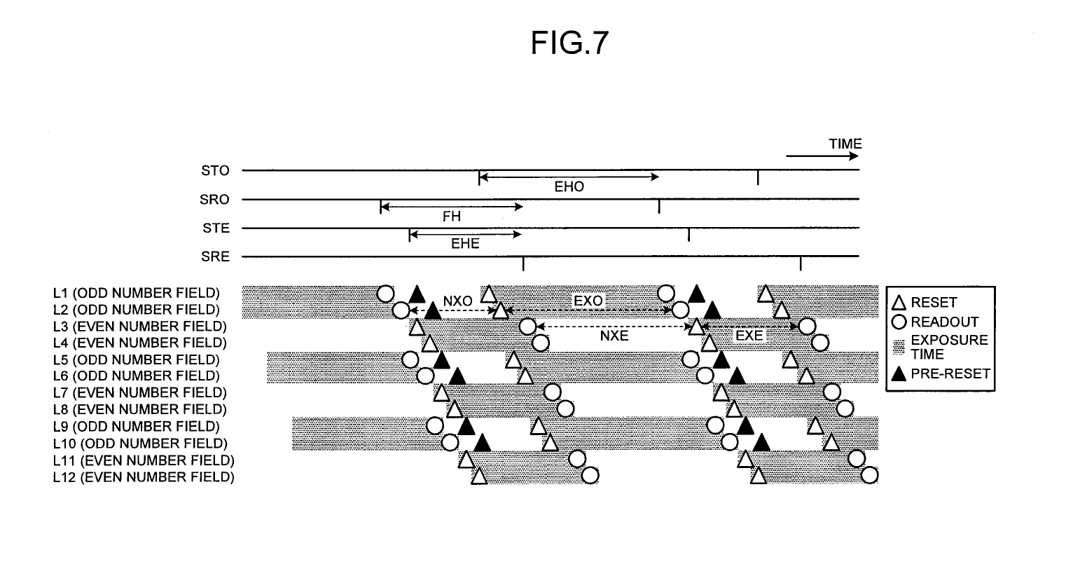

FIG. 7 is a timing chart of reset timings and readout timings for the odd number fields and the even number fields under a fourth condition in each of the lines. The fourth condition is that one of the odd number field exposure time EHO and the even number field exposure time EHE is equal to or longer than the one frame time FH, the other is shorter than the one frame time FH, and a sum of the shorter exposure time and the one frame time FH is longer than the longer exposure time. Under the fourth condition, pre-reset of a non-exposure period in only a field in which the non-exposure period is shorter is performed. In an example shown in FIG. 7, the odd number field exposure time EHO is longer than the even number field exposure time EHE. Under the fourth condition, pre-reset does not have to be performed in the odd number field non-exposure period NXO and the even number field non-exposure period NXE.

In FIG. 7, when the odd number field exposure time EHO is equal to or longer than the one frame time FH, the even number field exposure time EHE is shorter than the one frame time FH, and a sum of the even number field exposure time EHE and the one frame time FH is equal to or shorter than the odd number field exposure time EHO, the odd number field non-exposure period NXO is shorter than the one frame time FH and the even number field non-exposure period NXE is longer than the one frame time FH. At this point, when pre-reset is not performed in the even number field non-exposure period NXE, it is possible to prevent pre-reset from being inserted into a position where the pre-reset cannot be matched with reset timings for the odd number fields and the even number fields. Therefore, it is possible to prevent complication of a circuit configuration.

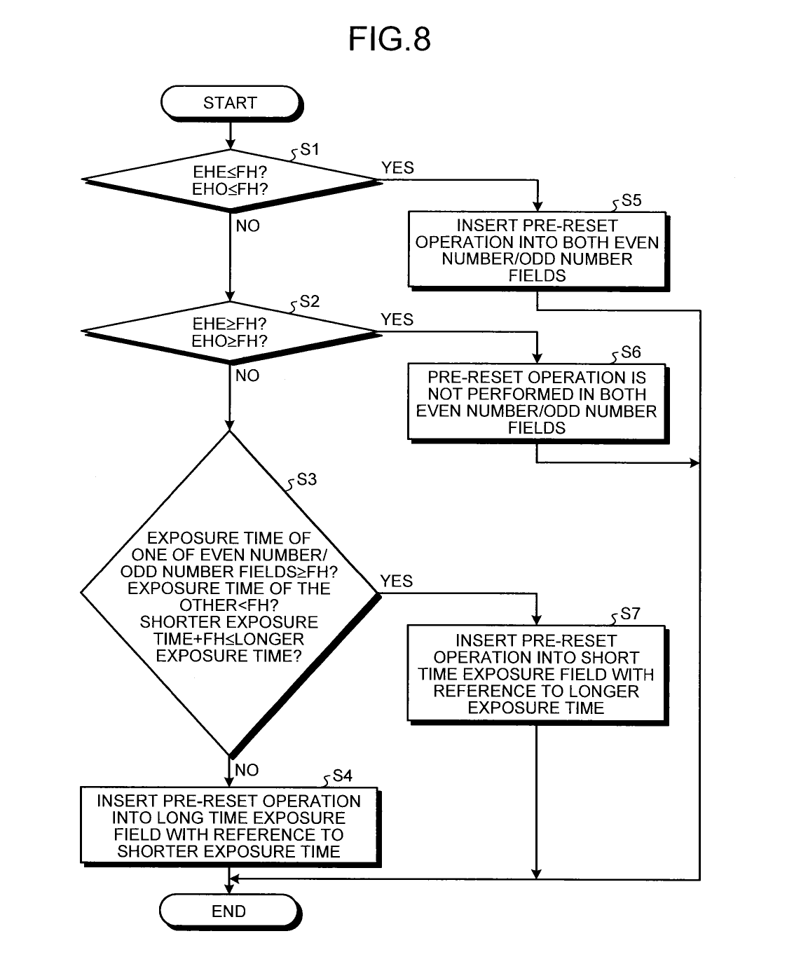

FIG. 8 is a flowchart for explaining pre-reset operations under the first to fourth conditions shown in FIGS. 4A to 7.

In FIG. 8, it is determined whether the odd number field exposure time EHO and the even number field exposure time EHE are shorter than the one frame time FH (the first condition) (S1). When the odd number field exposure time EHO and the even number field exposure time EHE are shorter than the one frame time FH, a pre-reset operation is inserted in the odd number field non-exposure period NXO and the even number field non-exposure period NXE (S5).

On the other hand, when the first condition is not satisfied, it is determined whether the odd number field exposure time EHO and the even number field exposure time EHE are equal to or longer than the one frame time FH (the second condition) (S2). When the odd number field exposure time EHO and the even number field exposure time EHE are equal to or longer than the one frame time FH, a pre-reset operation is not inserted in the odd number field non-exposure period NXO and the even number field non-exposure period NXE (S6).

On the other hand, when the second condition is not satisfied, it is determined whether one of the odd number field exposure time EHO and the even number field exposure time EHE is equal to or longer than the one frame time FH, the other is shorter than the one frame time FH, and a sum of the shorter exposure time and the one frame time FH is equal to or shorter than the longer exposure time (the third condition) (S3). When one of the odd number field exposure time EHO and the even number field exposure time EHE is equal to or longer than the one frame time FH, the other is shorter than the one frame time FH, and the sum of the shorter exposure time and the one frame time FH is equal to or shorter than the longer exposure time, a pre-reset operation is inserted into a short time exposure field with reference to the longer exposure time (S7).

On the other hand, when the third condition is not satisfied (the fourth condition), a pre-reset operation is inserted into a long time exposure field with reference to the shorter exposure time (S4).

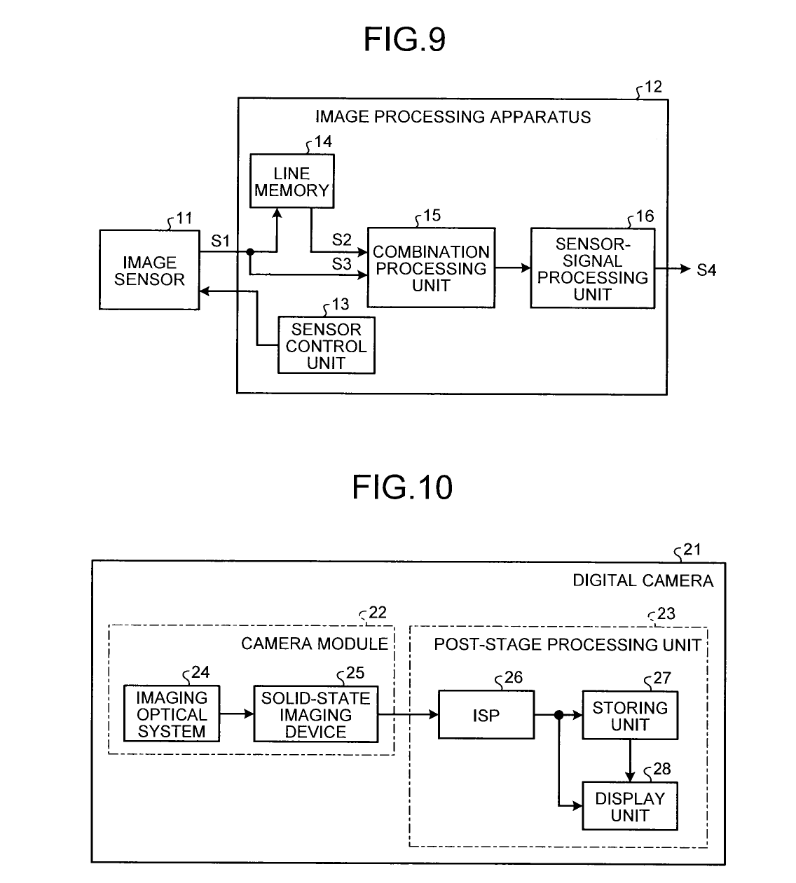

FIG. 9 is a block diagram of the schematic configuration of an image processing apparatus that combines signals read out in the odd number field exposure period and the even number field exposure period.

In FIG. 9, in an image processing apparatus 12, a sensor control unit 13, a line memory 14, a combination processing unit 15, and a sensor-signal processing unit 16 are provided. The image processing apparatus 12 is connected to an image sensor 11. As the image sensor 11, the configuration shown in FIG. 1 can be used.

The sensor control unit 13 generates a control signal according to user operation or the like and supplies the control signal to the sections of the image sensor 11 to control the image sensor 11 to operate according to the user operation. The sensor control unit 13 can control the image sensor 11 to generate, for example, the output signal S1 in which exposure times are separately set for the odd number fields and the even number fields.

The line memory 14 can separate, for each of exposure periods, the output signal S1 output from the image sensor 11 and output the output signal S1 with timing of the output signal S1 for each of the exposure periods set the same. The combination processing unit 15 can generate an image signal having an expanded dynamic range by combining the output signals S1 in the odd number fields and the even number fields. The sensor-signal processing unit 16 can perform signal processing such as white balance adjustment, demosaic processing, and image quality adjustment.

In the line memory 14, for example, an output signal S2 in the odd number fields in the output signals S1 in the odd number field is stored. At timing of the next line readout, when an output signal S3 in the even number fields is output from the image sensor 11, at the same time, the output signal S2 in the odd number fields is read out from the line memory 14 and sent to the combination processing unit 15. After the output signals S2 and S3 are combined in the combination processing unit 15, the signal processing is performed in the sensor-signal processing unit 16, whereby an image signal S4 having an expanded dynamic range is output.

In the embodiment explained above, the method of performing the discharge of the charges accumulated in the photodiode PD once or less in the odd number field non-exposure period NXO and performing the discharge once or less in the even number field non-exposure period NXE is explained. However, the discharge can be performed two or more times.

In the embodiment, the method of setting, for each of the lines, the two different exposure times for the long time exposure and the short time exposure to expand a dynamic range is explained. However, three different exposure times for long time exposure, medium time exposure, and short time exposure can be set for each of the lines or four or more different exposure times can be set for each of the lines.

### Second Embodiment

FIG. 10 is a block diagram of the schematic configuration of a digital camera applied with a solid-state imaging device according to a second embodiment.

In FIG. 10, a digital camera 21 includes a camera module 22 and a post-stage processing unit 23. The camera module 22 includes an imaging optical system 24 and a solid-state imaging device 25. The post-processing unit 23 includes an image signal processor (ISP) 26, a storing unit 27, and a display unit 28. As the solid-state imaging device 25, the configuration shown in FIG. 1 can be used. At least a part of components of the ISP 26 can be integrated as one chip together with the solid-state imaging device 25.

The imaging optical system 24 captures light from an object and images an object image. The solid-state imaging device 25 picks up the object image. The ISP 26 subjects an image signal obtained by the image pickup in the solid-state imaging device 25 to signal processing. The storing unit 27 stores an image subjected to the signal processing in the ISP 26. The storing unit 27 outputs the image signal to the display unit 28 according to user operation or the like. The display unit 28 displays the image according to the image signal input from the ISP 26 or the storing unit 27. The display unit 28 is, for example, a liquid crystal display. Besides the digital camera 21, the camera module 22 can be applied to an electronic apparatus such as a portable terminal with a camera.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array section in which pixels that accumulate photoelectrically-converted charges are arranged in a matrix shape;
an exposure-period control section configured to control an exposure period of the pixels for each of fields and control readout timing such that interlace readout can be performed from the pixel array section; and
a charge-discharging control section configured to perform discharge control for charges accumulated in the pixels in a non-exposure period of the pixels.

2. The solid-state imaging device according to claim 1, wherein the exposure-period control section includes:
a readout-timing control section configured to control the readout timing such that the interlace readout is performed from the pixel array section;
an odd-number-field-reset-timing control section configured to control reset timing for charges accumulated in the pixels in an odd number field; and
an even-number-field-reset-timing control section configured to control reset timing for charges accumulated in the pixels in an even number field.

3. The solid-state imaging device according to claim 2, wherein the charge-discharging control section includes a pre-reset-timing control section configured to control the reset timing for the charges accumulated in the pixels in the odd number field or the even number field in a non-exposure period of the odd number field or the even number field.

4. The solid-state imaging device according to claim 3, wherein the pre-reset-timing control section sets the reset timing for the non-exposure period of the odd number field or the even number field based on a length relation among an odd number field exposure time, an even number field exposure time, and one frame time.

5. The solid-state imaging device according to claim 4, wherein, when the odd number field exposure time and the even number field exposure time are shorter than the one frame time, the solid-state imaging device performs reset of the odd number field non-exposure period and the even number field non-exposure period.

6. The solid-state imaging device according to claim 4, wherein, when the odd number field exposure time and the even number field exposure time are equal to or longer than the one frame time, the solid-state imaging device does not perform reset of the odd number field non-exposure period and the even number field non-exposure period.

7. The solid-state imaging device according to claim 4, wherein, when one of the odd number field exposure time and the even number field exposure time is equal to or longer than the one frame time, the other is shorter than the one frame time, and a sum of the shorter exposure time and the one frame time is equal to or shorter than the longer exposure time, the solid-state imaging device performs reset of a non-exposure period in only a field in which the non-exposure period is longer.

8. The solid-state imaging device according to claim 4, wherein, when one of the odd number field exposure time and the even number field exposure time is equal to or longer than the one frame time, the other is shorter than the one frame time, and a sum of the shorter exposure time and the one frame time is longer than the longer exposure time, the solid-state imaging device performs reset of a non-exposure period in only a field in which the non-exposure period is shorter.

9. The solid-state imaging device according to claim 1, further comprising:
a vertical scanning circuit configured to scan a readout target pixel in a vertical direction;
a load circuit configured to perform a source follower operation between the load circuit and the pixel to thereby read out a signal from the pixel to a vertical signal line for each of columns;
a column ADC circuit configured to detect signal components of the pixels in a CDS for each of the columns; and
a horizontal scanning circuit configured to scan the readout target pixel in a horizontal direction.

10. The solid-state imaging device according to claim 1, wherein a time interval between lines of reset timing for the non-exposure period is equal to a time interval between lines of reset timing for starting the exposure period.

11. The solid-state imaging device according to claim 1, wherein the pixel includes:
a photodiode configured to perform photoelectric conversion;
a readout transistor configured to transfer a signal from the photodiode to a floating diffusion based on a readout signal;
a reset transistor configured to reset, based on a reset signal, a signal accumulated in the floating diffusion; and
an amplifier transistor configured to detect potential of the floating diffusion.

12. The solid-state imaging device according to claim 1, wherein
the pixels form a Bayer array, and
the odd number fields and the even number fields are alternately set for every two lines.

13. The solid-state imaging device according to claim 1, wherein further comprising a combination processing section configured to combine an output signal obtained from a pixel in an odd number field and an output signal obtained from a pixel in an even number field.

14. The solid-state imaging device according to claim 13, further comprising a line memory configured to separate an output signal output from the pixel array section for each of the exposure periods and output the output signal with timing for the output signal for each of the exposure period set the same.

15. The solid-state imaging device according to claim 1, wherein the charge-discharging control section performs discharge control for charges accumulated in the pixel during the non-exposure period of the pixel a plurality of times for each of lines.

16. A solid-state imaging device comprising:
a pixel array section in which pixels that accumulate photoelectrically-converted charges are arranged in a matrix shape;
a vertical scanning circuit configured to scan a readout target pixel in a vertical direction;
a load circuit configured to perform a source follower operation between the load circuit and the pixel to thereby read out a signal from the pixel to a vertical signal line for each of columns;
a column ADC circuit configured to detect signal components of the pixels in a CDS for each of the columns;
a horizontal scanning circuit configured to scan the readout target pixel in a horizontal direction;
an exposure-period control section configured to control an exposure period of the pixels for each of fields and control readout timing such that interlace readout can be performed from the pixel array section; and
a charge-discharging control section configured to perform discharge control for charges accumulated in the pixels in a non-exposure period of the pixels, wherein
the exposure-period control section includes:
a readout-timing control section configured to control the readout timing such that the interlace readout is performed from the pixel array section;
an odd-number-field-reset-timing control section configured to control reset timing for charges accumulated in the pixels in an odd number field; and
an even-number-field-reset-timing control section configured to control reset timing for charges accumulated in the pixels in an even number field.

17. The solid-state imaging device according to claim 16, wherein the charge-discharging control section includes a pre-reset-timing control section configured to control the reset timing for the charges accumulated in the pixels in the odd number field or the even number field in a non-exposure period of the odd number field or the even number field.

18. The solid-state imaging device according to claim 17, wherein the pre-reset-timing control section sets the reset timing for the non-exposure period of the odd number field or the even number field based on a length relation among an odd number field exposure time, an even number field exposure time, and one frame time.

19. The solid-state imaging device according to claim 16, wherein
the pixels form a Bayer array, and
the odd number fields and the even number fields are alternately set for every two lines.

20. The solid-state imaging device according to claim 19, wherein further comprising a combination processing section configured to combine an output signal obtained from a pixel in an odd number field and an output signal obtained from a pixel in an even number field.
